(19) United States
(12) Patent Application Publication
(10) Pub. No.: US 2008/0023377 A1
(43) Pub. Date: Jan. 31, 2008

(54) Dycon gravity mineral recovery apparatus and process

(76) Inventor: George P. Baummer, Panama City, FL (US)

Correspondence Address: Peter Loffler, P.O. Box 1001, Niceville, FL, 32588-1001, US

(21) Appl. No.: 11/492,644

(22) Filed: Jul. 25, 2006

(51) Int. Cl. B03B 11/00; B07B 11/00

(52) U.S. Cl. 209/490

(57) ABSTRACT

A gravity mineral recovery apparatus and process uses stratification to separate the relatively heavier valuable particulates from the lighter tailings in ore. A housing holds a process chamber therein, the chamber capable of oscillating within the housing. Ore is gravity fed into the process chamber and falls toward the bottom with the ore channeled to the outer sidewall of the process chamber by a deflector that creates an annular passage within the chamber. The oscillation of the chamber causes the heavier particulate to stratify into circumferentially disposed hoppers while the tailings are discharged through a central chute to a tailings hopper. The hoppers have compound sloped sidewalls and have a sensor for opening a discharge valve within the hopper once a given concentration is achieved. A series of sensors within the tailings hopper control a tailings discharge valve as well as an ore feed valve. Water constantly flows through the system yet does not participate in the actual transport of the particulates.

The application claims the benefit of Disclosure Document number 570647

### BACKGROUND OF THE INVENTION

1. Field of the Invention

The present invention relates to a gravity mineral beneficiation apparatus and process for use in the mining industry. I have been granted three United States patents for such devices and processes, U.S. Pat. Nos. 3,537,581, 4,120,783, and 5,057,211, all of which are incorporated, herein by reference.

2. Background of the Prior Art

### Fundamental Differences and Inherent Limitations

The reason there are “inherent limitations” common to all gravity separators prior to DYCON is that there are basic functions that cause these limitations that are common to all of these devices, functions that have been retained from ancient times to the present. The most consequential common basic function that has remained in all prior devices, which is now uniquely eliminated with the new DYCON concept, is the unbroken flow-path of particulate matter that is being processed through their circuits, from input to output, past the critical point within their circuits where the separation of heavies from lights is to (hopefully) take place.

Totally unique with the new DYCON concept, the flow-path of particulate matter through the DYCON circuit is interrupted with a “functional buffer zone”. This unique zone is designed to create an ideal environment for complete gravity separation while eliminating the common restrictions of all prior gravity separators. Also, conditions within this unique zone never change, providing continuous and consistent recovery efficiency whether processing as little as 100 lbs. or millions of tons of ore. This type of DYCON gravity separation engineering is not possible within the configuration of any of the prior gravity separators.

This fundamental difference is the foundation for the many unique DYCON advantages described in the following.

### Elements Involved with Gravity Primary Mineral Recovery

The elements listed in the following (functions, reactions to functions and other factors) are involved with gravity primary mineral processing where the requirement is to (A) efficiently separate the valuable constituents from the waste material in an ore feed while (B) producing these valuable constituents in a useful concentrated form. Having precisely identified these elements, a direct comparison between the two opposing methods, the new DYCON SYSTEM versus all other prior gravity separators can be made concerning the presence and elimination of the specific elements listed and the resulting effects within these two opposing methods on achieving (A) the separation and (B) the concentration required for commercial applications. With this comparison the extraordinary extent of innovation and decisive DYCON advantages will become apparent. The new “DYCON SYSTEM” is truly unique, technically sound and a long-overdue breakthrough in the field of gravity separation for placer mining.

### The Elements—a Checklist for Comparison

1) AN UNBROKEN FLOW PATH OF PARTICULATE MATTER THROUGH THE ENTIRE CIRCUIT FROM INPUT TO OUTPUT (all prior gravity separators)
2) FLOW PATH OF PARTICULATE MATTER THROUGH THE CIRCUIT IS INTERRUPTED WITH A UNIQUE BUFFER ZONE (only in the new DYCON SYSTEM)
3) HYDROLOGIC EQUILIBRIUM OR COMBINED HYDROLOGIC AND CENTRIFUGAL EQUILIBRIUM
4) TRANSPORTING FLUID FLOW RATES (direct and opposing)
5) PARTICLE SIZE LIMITATIONS AND RELATIONSHIPS
6) FEED DENSITY (over or underfeeding)
7) FIXED ENRICHMENT RATIOS OR EQUIVALENTS
8) LIMITS OF CONCENTRATION OR ENRICHMENT LEVELS (final product)
9) STAGING AND RECYCLING MIDDLING
10) CONTROL OF EXPOSURE TIME
11) AUTOMATIC THROUGH-PUT (electronically controlled)
12) CONCENTRATION LEVEL ELECTRONICALLY DISPLAYED

Consider individually each element listed, beginning with #1 and #2. #1 is the unbroken flow path, of particulate matter common to all prior gravity separators. #2 is the unique “buffer zone” interrupting the flow path of particulate matter with the DYCON SYSTEM. This structural difference is the foundation for the many DYCON advantages.

### #3 Hydrologic Equilibrium or Combined Hydrologic and Centrifugal Equilibrium

With the unbroken flow path in all prior gravity separators, it is not possible to eliminate the negative effects of the hydrologic equilibrium that occurs in a fluvial transport between particles of different specific gravities because of their relative sizes and shapes. This is the result, because of the inseparable flow paths (particulates and fluid), of having to set the slurry flow rate at a velocity sufficient to transport the entire range of particle sizes. Stated simply, under these circumstances, in a fluvial transport the very small gold particles in a hydrologic equilibrium state with larger waste particles will remain in suspension and be discharged into the tailings. These same conditions of “equilibrium” are also present and even more exaggerated in the centrifugal separators, particularly those that employ both direct and opposing fluid currents, necessitating even closer tolerances in particle size differences, feed density and flow rates, compared with the open sluices.

In the attempt to minimize the negative effects caused by the #3 HYDROLOGIC EQUILIBRIUM in prior gravity separators, the elements involved, #4 TRANSPORTING FLUID FLOW RATES, #5 PARTICLE SIZE LIMITATIONS AND RELATIONSHIPS, and #6 FEED DENSITY, all must be maintained in a delicately balanced relationship with each other by holding each element individually to very close tolerances. These sensitive conditions do not permit the consistent performance and reliable high percentage recoveries necessary for the extended commercial applications projected for DYCON. In sharp contrast these sensitivities to variables, with their direct negative impact on performance are entirely eliminated with the unique DYCON buffer zone. These elements, equilibrium, feed density, fluid carrier flow rates and particle size differences are of no consequence and have absolutely no influence in the new DYCON SYSTEM.

### Inside the Unique Dycon Buffer Zone

By its very presence the unique DYCON buffer zone totally eliminates the hydrologic equilibrium effect which is a major limitation present in all other gravity separators prior to DYCON. A closer examination of just this one aspect of what this unique zone actually accomplishes will further clarify the reasons why this exclusive feature is a very decisive DYCON advantage.

When not influenced by any other transporting force other than gravity alone, particulate matter in an agitated state will separate and stratify for two natural reasons: 1) particle size differences, and 2) specific gravity differences. However, under the influence of any transporting force other than gravity alone, as in all other prior gravity separators, these two elements are in direct conflict with each other, substantially hindering and limiting gravity separation for the reasons explained in the preceding concerning equilibrium and the related elements.

Once again, in sharp contrast to all prior gravity separators, having eliminated the hydrologic equilibrium effect, the new DYCON SYSTEM allows both elements: (1) particle size differences and (2) specific gravity differences, to react and function naturally, each in its own way, unobstructed and in perfect harmony together, with each contributing to the most efficient gravity separation possible when involving particulate matter of the type required for commercial gravity primary mineral recovery.

### Producing a Useful Concentrate

As noted in the preceding under the heading “ELEMENTS INVOLVED WITH GRAVITY PRIMARY MINERAL RECOVERY”, there are two requirements: (A) efficient separation of valuable constituents from waste, while (B) producing these valuable constituents in a useful concentrated form. The elements previously described and identified on the “Checklist” as elements #3, #4, #5 and #6 all have a direct bearing on (A) efficient separation. The focus will now shift to the second requirement and the elements involved with (B) producing a useful concentrate.

Before proceeding it is important to put the unique DYCON buffer zone into clear perspective. Although this unique zone can be considered as a single structural difference, this zone has a direct and profound effect on all the many elements identified on the Checklist for comparison.

### #7 Fixed Enrichment Ratios or Equivalents

To meet the first requirement (A) efficient separation, the one particular element central to all the DYCON separating advantages, an element which is eliminated with the DYCON buffer zone, is #3, the HYDROLOGIC EQUILIBRIUM EFFECT. Similarly, to meet the second requirement (B) production of a useful concentrate, there is also one element central to all the DYCON advantages for this function. This element is also eliminated with the DYCON buffer zone—namely #7 THE FIXED ENRICHMENT RATIOS OR EQUIVALENTS that are present in all gravity separators prior to DYCON.

A fixed enrichment ratio is the result of a continuous discharge into the concentrates, a fixed percentage of the ore being processed. A fixed enrichment ratio equivalent is the “concentrating cycle time” for clean-up. The final result is the same for both—a very restrictive limitation on #8 ENRICHMENT LEVELS. See the following chart and example.

| | WEIGHT INTO | ENRICHMENT |
|---|---|---|
| DEVICE | CONCENTRATE | LEVEL |
| REICHERT MARK-7 SPIRAL | 5.4% | 19 x |
| KNELSON CONCENTRATOR | 4.2% | 24 x |
| DEISTER TABLE | .5% | 2O0 x |

### Significance of the Unique Dycon “Floating-Enrichment-Ratio”

Unlike prior gravity separators operating with a fixed enrichment ratio or equivalent, the new DYCON SYSTEM can be programmed to produce a consistent and high-grade concentrate regardless of input ore grade or any inconsistencies in ore feed. This is accomplished with a unique floating-enrichment ratio automatically responding electronically to feed conditions. Because of this unique feature, the DYCON SYSTEM can also achieve far greater enrichment levels than with prior devices, as illustrated with the following example:

| | | | |
|---|---|---|---|
| DYCON | ENRICHMENT LEVEL | 6,000,000 | TIMES |
| SPIRAL | ENRICHMENT LEVEL | 19 | TIMES |

For comparison, consider each system processing with a SINGLE-PASS (without staging or recycling middlings), 6,000,000 tons of placer ore containing 0.5 PPM (0.0145 oz/ton) fine-flake gold:

DYCON The DYCON SYSTEM could be programmed to produce a concentrate that would contain, BY VOLUME, 40% GOLD AND 60% WASTE. On that basis the total gold available (87,000 ozs.), following the processing of the entire 6,000,000 tons of ore, would be recovered and concentrated in a volume equal to ONE TON of the original ore.

| | |
|---|---|
| Note: 1 short ton = | 40% by volume = 11,666 ozs × a gold density |
| 29,166 troy ozs. | multiple of 7.5 equals 87,495 ozs of gold |

SPIRAL The SPIRAL would be operating with a fixed-enrichment-ratio continually discharging into concentrate 5.4% of the ore being processed, per preceding chart. Processing 6,000,000 tons of ore with a SINGLE-PASS would result in the production of a so-called “concentrate” equal in volume to 324,000 TONS of ore compared with only ONE produced with the DYCON SYSTEM.

The large tonnage used in the preceding comparison is to provide a more accurate simulation of an actual high volume commercial operation. The comparison indicates that with DYCON and the Spiral processing an equal amount of material with a single pass, the final product for DYCON was equal to the volume of one ton. The final product for the Spiral was equal to 324,000 tons. As a point of reference for comparison, if a Table was used for final clean-up having the capacity of 500 lbs/hr, final cleanup for DYCON would be completed in just 4 hrs. As incredible as it will first appear, the numbers show that the 324,000 tons of “concentrate” produced by the Spiral if reprocessed at a rate of 500 lbs an hour, 24 hrs/day, it would require 148 YEARS. Even so the next “concentrate” produced by the Table would still be equal in volume to 1,620 tons since the Table functions with a fixed enrichment ratio of approximately 200:1.

This comparison is made to underscore the presence of another major “inherent limitation” common to all gravity separators prior to DYCON. However, applying such a method of direct clean-up following a single pass of ore through a primary recovery circuit of any prior gravity separator is of course far beyond any practical reasoning. The point to be made is that a fixed enrichment ratio or equivalent, compared with no such restriction with DYCON, will produce massive quantities of “concentrate” requiring additional reprocessing.

This necessary continued reprocessing (#9 STAGING AND RECYCLING MIDDLINGS) in order to attempt to achieve (B) “a useful concentrate”, substantially compounds the initial losses when proceeding through additional successive stages. The losses occur for the same reasons explained concerning the “Hydrologic Equilibrium Effect. In fact, it has been reported that when processing “placer gold concentrates” losses usually exceed those sustained during the initial primary recovery operation. It is reasoned that the cause is the increased ratio of heavy black sands in the “concentrate” compared with the original ore.

### Review

Referring to the “Checklist for Comparison” element #1 and #2 define the structural difference between all prior gravity separators and the new “DYCON SYSTEM”. Elements #3 through #9 all translate into negative factors causing the “inherent limitations” common to all prior gravity separators. These elements are eliminated with the unique DYCON buffer zone. Elements #10, #11 and #12 represent other advanced technology in the field of gravity primary mineral recovery exclusive to DYCON.

There are also other advantages included within the DYCON SYSTEM but not described in the preceding, such as adjustable exposure time, elimination of the negative effect of surface tension, and the ability to accommodate both barren ore and ore hot spots—which is a capability beyond prior gravity separators.

### #10 Control of Exposure Time

Control of Exposure Time refers to the amount of time that the ore containing heavier valuable constituents is subjected to the separating and stratification processes within the Stratification Zone(s) of the Process Chamber. The purpose for adjusting Exposure Time is to achieve maximum throughput capacity while maintaining maximum recovery efficiency. This is not an option with prior art devices and processes because of their unbroken flow paths and fluvial transport as explained in the preceding under #3 HYDROLOGIC EQUILIBRIUM . . . ”

The adjustable elements that determine Exposure Time, the gravity induced flow rate of particulate matter, begins with an adjustable Descent Angle in the particulates flow path between the Annular Passageway at the lower periphery of the Upper Compartment of the Process Chamber, through which the particulate matter enters into the Stratification Zone(s) enroute to the centrally located Spillway Lip in the Lower Compartment. This same area also defines the principal “BUFFER ZONE” in the Process System. The particulate matter, following processing, is then discharged over the Spillway Lip into the Tailings Temporary Hold Compartment which is outside the two-compartment Process Chamber. The adjustment of the Descent Angle is made by raising or lowering the interlocking Upper Compartment Assembly within the Lower Compartment Assembly. The Upper Compartment Assembly consists of an Outer Sleeve to which an Inner Distribution Cone is attached defining the Annular Passageway at the low end periphery. Included as part of the Lower Compartment Assembly is a mounted plate that holds the Agitator Rods that penetrate into the Stratification Zone(s) to keep the entire bed of passing and retained particulate matter in an agitated state to induce separation and stratification. The other adjustable elements involved with the control of Exposure Time are the Oscillation Rate and Amplitude of the agitation that is applied to the Process Chamber in combination with a selected Descent Angle.

### #11 Automatic Throughput (Electronically Controlled) and #12 Concentration Level Electronically Displayed

As disclosed in the preceding, the “DYCON GRAVITY MINERAL RECOVER APPARATUS AND PROCESS” with the description of its structure and function relationships within the two-compartment Process Chamber, will now be referred to as a component within a complete Process System with automatically coordinated functions, all of which when combined together is a unique “Process System” in the field of gravity mineral processing and an extension of the underlying invention.

An essential component of the complete Process System is the “Automatic Choke Valve” with its function of coupling a conventional ore feed into the operating mineral process chamber and at a rate that is coordinated with the processing rate (Exposure Time) set within the Process Chamber and also coordinated with the discharge rate of tailings from the System. This is accomplished with the placement of the output opening of the Automatic Choke Valve at a prescribed level above the Distribution Cone in the Upper Compartment of the Process Chamber, all of which is submerged in a water tank. The ore feed is under no pressure other than gravity and as the particulate matter accumulates on the top surface of the Distribution Cone, filling a prescribed area within the upper compartment, to the level of the output opening of the Automatic Choke Valve, the rate of particulate matter entering into the System will be choked or governed in direct proportion to its discharge through the Annular Passageway into the lower compartment of the Process Chamber. Following the processing of the particulate matter through the Stratification Zone(s) in the lower compartment of the Process Chamber, the processed particulate matter (tailings) enters a Temporary Tailings Hold Compartment which is also housed within the water tank—This Temporary Tailings Hold Compartment has an electronically controlled discharge valve to expel the tailings from the Process System. The discharge valve is controlled by a sensor that limits the amount of particulate matter allowed to accumulate within the Temporary Tailings Hold Compartment. The water tank also includes a means to automatically maintain a prescribed water level within the tank while continually infusing clean water into the circuit to replace expelled silt-laden water.

The criteria for component relationships to achieve the automatic throughput is as follows:

Ore feed through the “Automatic Choke Valve” into the operating mineral Process Chamber must be capable of a feed rate slightly greater than that of the maximum processing rate. Also, the tailings discharge valve, when fully open must be capable of a discharge rate slightly greater than that of the ore feed rate. With these criteria in place the electronic circuitry and sensors will automatically coordinate the tailings discharge with the ore input, with the ore input controlled by the Automatic Choke Valve, which is directly coupled and responsive to the rate the ore is being processed (Exposure Time). Once the unit is activated the System will continue to operate automatically with the concentration level of the values retained within the System being electronically displayed in response to a sensor, in preparation for removal.

### The Negative Effect of Surface Tension

In prior art devices and processes, surface tension can cause small valuable metallic particles to float and then be flushed through their systems uncaptured. This is particularly true with very fine flake gold. The present invention eliminates this possibility by delivering the ore into the System below the water surface through the “Automatic Choke Valve.” The ore remains below the water surface throughout the entire process, never being exposed to Surface Tension.

### Accommodation for Both Barren Ore and Ore Hot Spots

The ability to accommodate both barren ore and ore hot spots, which is a capability beyond prior art gravity separators, involves the difficulty of coping with the inconsistent distribution of valuable constituents throughout an ore feed, particularly with gold placer mining. Under these conditions the difficulty is to achieve high percentage recovery of the heavy valuable constituents while also producing these valuable constituents in a useful concentrated form. These necessary two requirements are in conflict with each other in prior art devices and processes. For example, with the undercut devices and processes their design is to cut the lower strata of a fluvial transported ore and preserve this undercut portion of the ore as their “concentrate.” This discharge of their concentrate continues at a rate determined by the adjusted size of the undercut port regardless of whether the ore is barren or if it contains values. This uninterrupted discharge is a fixed percentage of the ore being processed. The dilemma is that if the undercut is set for a relatively high rate of discharge to attempt to improve recovery, their concentrate is continually degraded by the excess amount of waste matter being accumulated as part of their concentrate. On the other hand if the undercut is set at a relatively low rate of discharge in an attempt to improve the quality of the concentrate, increased amounts of the valuable constituents will be lost, and particularly so if an unusually high level of concentrated values (ore hot spots), passes the undercut ports.

With the present invention there is no difficulty in handling the natural inconsistent distribution of valuable constituents in an ore feed. The agitated beds of the stratification zone(s) within the Process Chamber maintain the same volume level of particulate matter regardless of the total amount of ore processed through the System (Exempt from Fixed Enrichment Ratio). With the operation of this process any barren ore present in the ore feed is simply expelled through the System and does not cause contamination by accumulating as part of the concentrate as it does in prior art systems. Concerning ore “hot spots”—an unusually high concentration of values in an ore feed—with the present invention “Exposure Time” can be adjusted to insure full recovery in such a circumstance, and thus the unique ability to accommodate both barren ore and ore hot spots.

### SUMMARY OF THE INVENTION

The Gravity Mineral Recovery Apparatus and Process of the present invention is comprised of a two-compartment Process Chamber that is submerged and operating within a multi-function Water Tank. The Water Tank is an integral part of the invention. The Process Chamber is pivotally-mounted within the tank and attached to an oscillating means that has both adjustable oscillation rate and adjustable amplitude.

The structure of the Process Chamber is comprised of two interlocking compartments, an Upper Compartment mounted into a Lower Compartment. The level to which the Upper Compartment is extended and fixed into the Lower Compartment is an adjustment in the function of the process. It determines an internal descent angle that is in the flow path of the particulate matter as it passes through the Process Chamber and is one of the controlling factors in the gravity-induced particulates flow-rate in combination with the oscillation agitation applied to the Process Chamber. This structural arrangement allows the particulate matter to be moved and processed through the Process Chamber free from the negative effect of a Fluvial Transport like that which is required in prior arts. In prior arts the Fluvial Transport causes a hydrologic equilibrium between the valuable very fine heavy specific gravity particles and the larger waste particles, preventing the separation and any effective recovery of these kinds of fine valuable particles with the use of prior arts.

The Upper Compartment of the Process Chamber is comprised of an outer sleeve to which a frusto-conical distribution cone is attached with spacers and thereby defining an Annular Passageway at the low end periphery of the Upper Compartment.

The Lower compartment of the Process Chamber has a centrally located exit opening in the bottom plate which is surrounded by a raised Spillway Lip over which the processed particulate matter is expelled from the Process Chamber. The area between the Annular Passageway of the Upper Compartment, through which the particulate matter enters into the Lower Compartment, and the Spillway Lip of the Lower Compartment, defines the Stratification Zone(s) in the Process System. Also, as part of the Lower Compartment there is a mounted plate holding an array of agitator rods that penetrate the entire stratification area. These rods are in sufficient number to keep the entire bed of particulate matter—both passing and retained particulates—in a fluidized state when working in conjunction with the oscillating Process Chamber. The Stratification Zone(s) has a valve controlled discharge exit from which the concentrated valuable constituents of the ore feed are removed. In this area there is a sensor providing a readout of the values concentration level to be used to initiate either an automatic or manual operation of the discharge value.

At the head of the Process System of the present invention and protruding into the Water Tank and into the Upper Compartment there is a funnel-shaped Automatic Choke Valve that controllably feeds a conventional ore source into the Upper Compartment of the operating Process Chamber. Placement of the outlet of the Automatic Choke Valve in relationship to the Distribution Cone in the Upper Compartment determines the level of particulate matter that is allowed into this area as it replaces the particulate matter that passes through the Annular Passageway into the Lower Compartment for processing. Following the processing of the ore through the Process Chamber the waste product particulate matter is expelled from the Process Chamber over the Spillway Lip that is part of the Lower Compartment. The particulate matter then falls into the cone-shaped bottom compartment of the Water Tank, which is a temporary hold compartment for the tailings (waste product). The Temporary Tailings Hold Compartment has an electronically-controlled discharge valve that responds to a sensor that only allows a specific amount of particulate matter to accumulate in the Hold Compartment. This discharge is timed so that the Temporary Tailings Hold Compartment is never fully emptied of particulate matter, thereby blocking any significant loss of water from the tank.

The Water Tank also includes a means for maintaining a prescribed water level and also a means for flushing out excessively silt-laden water. These dual functions are achieved with a controlled infusion of clean water into the tank at a low level below the Process Chamber. An overflow water exit is located in the top wall of the tank that determines the water level. Maintaining the water level requires a relatively modest flow rate for makeup water only. However, and determined by changing conditions, a far greater flow rate of incoming clean water may be required to flush out any excessively silt-laden water through the overflow water exit. This expelled water can then be cleaned and returned into the Process Circuit. The required flow rate of the incoming clean water to perform the dual functions is regulated by a valve that is electronically responding to a sensor that determines the silt level in the water within the tank.

The combined structural arrangement as described in this Summary allows all of the functions of the entire Process System to be fully coordinated automatically.

### BRIEF DESCRIPTION OF THE DRAWINGS

FIG. 1 is a sectional view of the gravity mineral recovery apparatus of the present invention utilizing five sensors, three concentrate discharge valves, and a rocker arm oscillation subsystem.

FIG. 2 is a sectional view of the gravity mineral recovery apparatus of the present invention utilizing two sensors, a single concentrate discharge valve, and a reciprocating rod oscillation subsystem.

FIG. 3 is a top plan view of the process chamber.

FIG. 4 is a sectional view of the process chamber taken along line 4-4 in FIG. 3.

FIG. 5 is a perspective view of the single discharge chamber schematically shown in FIG. 2.

FIG. 6 is a perspective view of the discharge chamber of FIG. 5 with the upper compartment raised with respect to the lower compartment

Similar reference numerals refer to similar parts throughout the several views of the drawings.

### DESCRIPTION OF THE PREFERRED EMBODIMENT

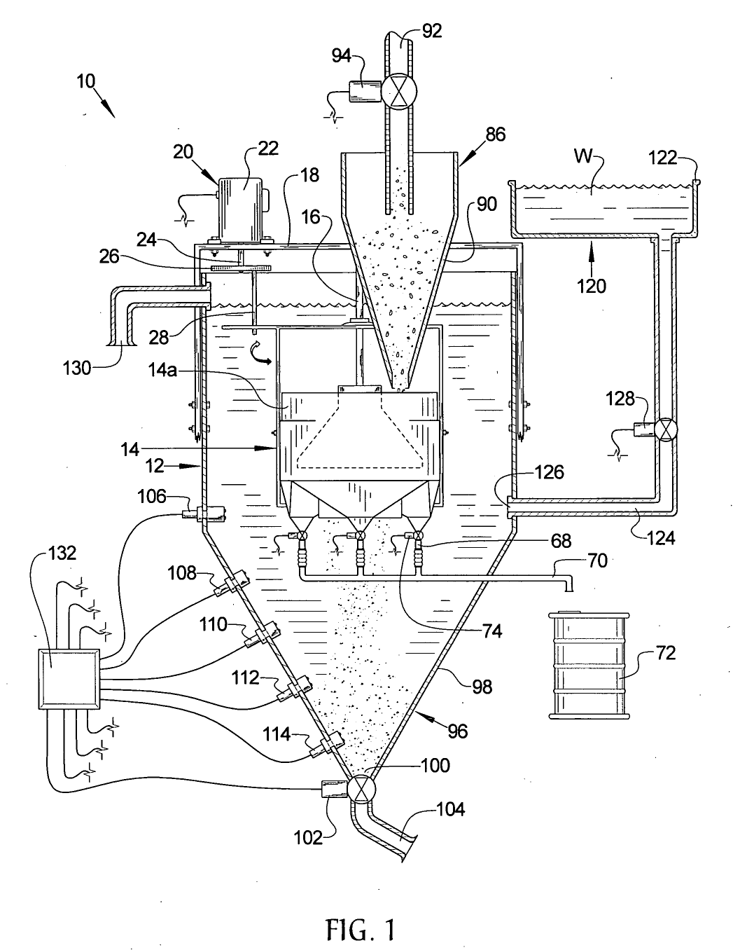

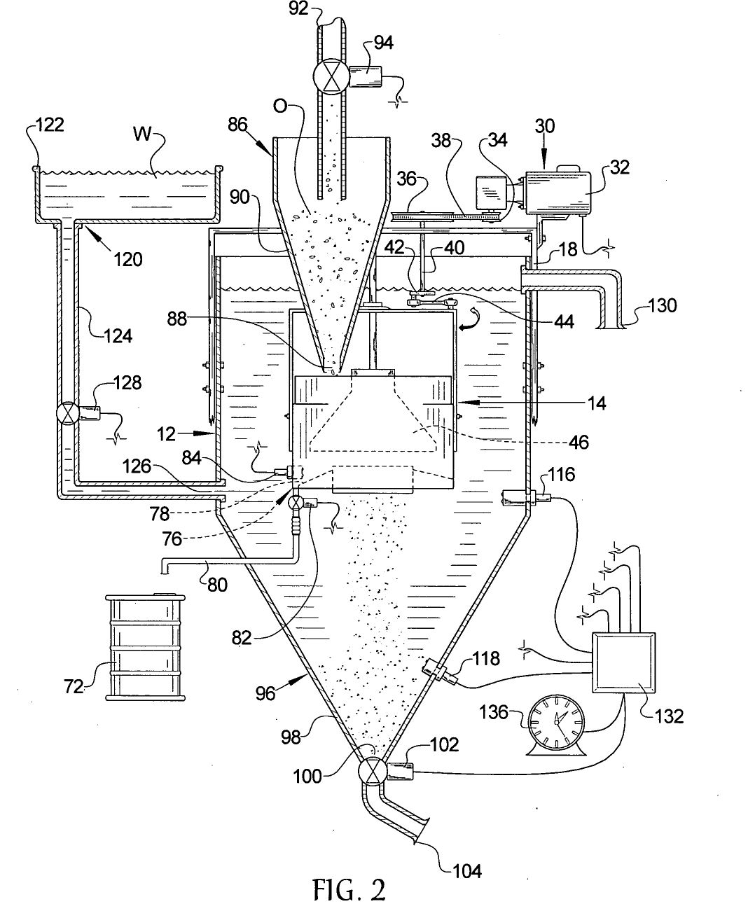

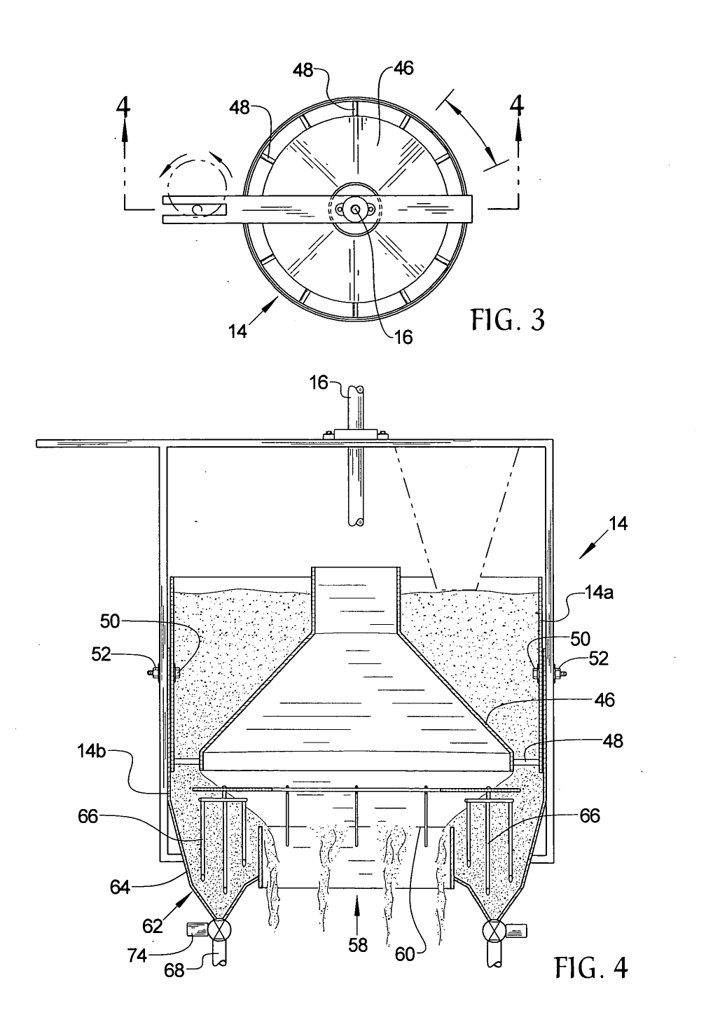

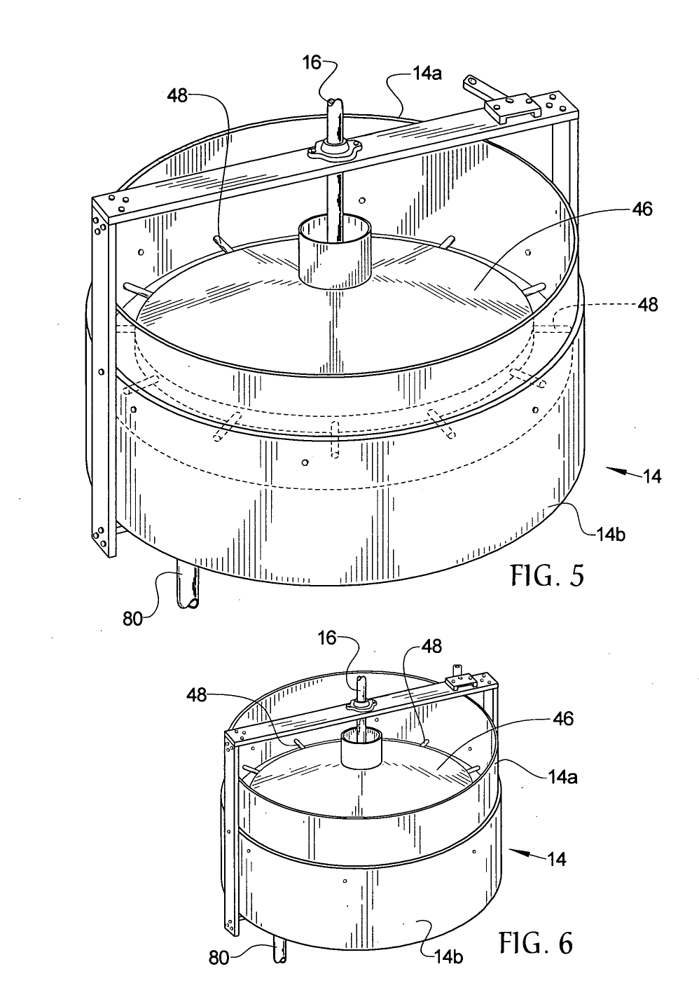

Referring now to the drawings, it is seen that the gravity mineral recovery apparatus of the present invention, generally denoted by reference numeral 10, is comprised of a housing 12 that has an interior chamber. Located within the housing 12 is a process chamber 14 that is rotatably attached to the housing by a shaft 16 that connects the process chamber 14 to a bracket 18 that is appropriately attached to the housing 12. The process chamber 14 is comprised of an upper compartment 14a and a lower compartment 14b wherein the upper compartment 14a may be raised and lowered within the lower compartment 14b in order to change the descent angle as more fully described below. The process chamber 14 is capable of oscillating about the shaft 16, which oscillation is accomplished by a rocker arm oscillation subsystem 20, illustrated in FIG. 1, wherein a motor 22 rotates a shaft 24 having a gear 26 thereon, with a centrally offset rocker arm 28 extending downwardly from the gear 26 and attaching to the process chamber 14. The motor 22 is attached to the bracket 18 and is electrically connected to a source of electrical power in usual fashion. Alternately, the oscillation can be accomplished by a reciprocating arm oscillation subsystem 30, illustrated in FIG. 2, wherein a motor 32 drives a first pulley 34 which is mechanically connected to a second pulley 36 by an appropriate belt 38, chain, etc., with the second pulley 36 driving a rod 40 that connects to a third pulley 42 that connects to a rocker arm 44, with the rocker arm 44 connected to the process chamber 14. This motor 32 is attached to the bracket 18 and is electrically connected to a source of electrical power in usual fashion.

A hollow upright tubular frustoconical deflector 46 is disposed within the process chamber 14 and attached therein by an appropriate mounting spacers 48. The deflector 46 is vertically adjustable within the process chamber 14 by moving the upper compartment 14a with respect to the lower compartment 14b. The upper compartment 14a is attached to the lower compartment 14b by any appropriate means such as the illustrated bolt 50 and nut 52 combination wherein the bolt 52 is receivable within aligned openings on both the upper compartment 14a and lower compartment 14b in order to secure the two units to one another. Several such opening pairs are provided so as to achieve the height adjustability of the upper compartment 14a with respect to the lower compartment 14b.

Located at the bottom of the process chamber 14 is a centrally disposed discharge chute 58 that has an upper annular lip 60. Also located at the bottom of the process chamber 14 are one or more stratification hoppers 62. As seen in FIGS. 1 and 4, multiple stratification hoppers 62 can be located about the outer circumference of the process chamber 14. As seen, each such stratification hopper 62 has compound sloped walls 64. A plurality of agitators 66 are vertically disposed within each stratification hopper 62. Located at the bottom of each stratification hopper 62 is a concentrates discharge conduit 68 that manifoldably connects to a main discharge conduit 70 with the main discharge conduit 70 depositing its output into an appropriate receptacle 72. An electrically controlled valve 74 is located at the bottom of each stratification hopper 62. Alternately, as seen in FIG. 2, a single stratification hopper 76 can be located at the bottom of the process chamber 14. This single stratification hopper 76 also has compound sloped sidewalls 78. Located at the bottom of this stratification hopper 76 is a concentrates discharge conduit 80 that deposits its output into the receptacle 72. An electrically controlled valve 82 is located at the bottom of this stratification hopper 76 as is a sensor 84, also located but not illustrated in the multiple stratification hoppers 62 configuration.

Located at the top of the housing 12 and partially descending into the top of the process chamber 14 is an ore hopper 86 that has an ore discharge opening 88 located at its bottom, with the sidewalls 90 of the ore hopper 86 tapered inwardly toward the discharge opening 88. Ore O is fed into the ore hopper 86 via an appropriate ore feed 92 that has an electrically controlled ore flow control valve 94 thereon for controlling the rate of ore O flow to the ore hopper 86.

Forming the lower chamber of the housing 12 is a tailings hopper 96, which may be integral with the housing 12. As seen, the sidewalls 98 of the tailings hopper 96 are inwardly tapered to a discharge opening 100 that has an electronically controlled tailing discharge valve 102. thereon. A discharge conduit 104 is located at the discharge opening 100. A series of sensors, designated 106, 108, 110, 112, and 114 in downwardly descending order in FIG. 1, and designated 116 and 118 in downwardly descending order in FIG. 2 are located within the housing 12.

A water feed system 120 is provided and has a reservoir 122 filled with water W with a conduit 124 that fluid flow connects the reservoir 122 within an inlet 126 on the housing 12. This inlet 126 is located below the top of the process chamber 14. An electrically controlled valve 128 is disposed within the conduit 124 to control the flow of water W therethrough and thus into the housing 12.

A fluid overflow sensor 130 is located at the top of the housing 12 above the top of the process chamber 14.

Appropriate electronic circuitry 132 is provided for controlling the various valves 74, 82, 94, 102, 128 and the oscillation subsystems 20 or 30 with input being provided to the circuitry from the various sensors either 84, 106, 108, 110, 112, and 114, or 116 and 118, and from an optional adjustable timer 136 in the case of the two sensor 116 and 118 configuration.

It is expressly understood that the configurations provided in the figures are for clarity and brevity and any appropriate combinations of the various elements can be configured in keeping within the scope and spirit the present invention 10.

In operation, the housing 12 is fluidized via water W that is fed into the housing 12, and thus into the process chamber 14, from the reservoir 122 of the water feed system. Ore O is fed into the gravity mineral recovery apparatus 10, from the ore hopper 86, which ore O is gravity fed into the upper compartment 14a of the process chamber 14. The process chamber 14 is oscillated by one of the oscillation subsystems 20 or 30. The frequency and amplitude of the oscillation can be controlled as desired. The oscillation of the process chamber 14 causes the particulates within the process chamber 14 to gravitationally settle to the bottom of the stratification hoppers 62 or 76. As oscillatory move continues to be imparted, the relatively heavier particulates tend to settle by gravity toward the lower areas of the stratification hoppers 62 or 76, thereby displacing the relatively lighter particulates. As oscillation continues, the relatively heavier particulates continue to displace the relatively lighter particulates until the relatively lighter particulates overflow the stratification hoppers 62 or 76 over the annular lip 60 of the discharge chute 58 and gravitationally falls into the tailings hopper 96. As this process continues, valuable constituents of the ore O are separated, concentrated, and ultimately discharged out through the concentrates discharges conduits 68 or 80. The agitators help keep the particulates within the stratification hoppers 62 or 76 fluidized thereby enhancing the stratification process. The sensor 84 located within each stratification hopper 62 or 76 senses for a preprogrammed concentration level of the valuable constituents within the stratification hoppers 62 or 76. When this concentration level is reached, the valves 74 or 82 are electrically opened in order to allow the valuable constituents to be discharged through the concentrate discharge conduits 68 or 80 and deposited into the receptacle 72. Once the concentration levels of the valuable constituents falls below a preprogrammed level, the valves 74 or 82 are closed.

The tailings are accumulated within the tailings hopper 96, with the accumulation of the tailings determining flow through the system. This is accomplished by the sensors 106, 108, 110, 112, and 114, or 116 and 118. In the five sensor configuration, the uppermost sensor 106 is the reference sensor and provides the threshold voltage that indexes the actions of the remaining sensors 108, 110, 112, and 114 through appropriate circuitry, such as a differential amplifier subtractor circuit. The lowermost sensor 114 acts as the minimum level sensor for the system. The tailings discharge valve 102 remains closed until the tailings accumulate beyond the level of the sensor 114. Once this sensor determines that such level has been reached, the next higher sensor 112 is activated and the tailings discharge valve 102 is partially opened to allow some of the tailings to discharge out of the housing 12 through the discharge opening 100 and then through the discharge conduit 104. Thereafter, should the lowermost sensor 114 go negative, meaning that the tailings level has fallen below the level of the lowermost sensor 114, then the tailings discharge valve 102 is closed indicating a minimum level of tailings. However, if the middle sensor 110 indicates that that the tailings level have reached this sensor, the tailings discharge valve 102 is further opened in order to allow the tailings to be discharged at a greater rate. The second from upper sensor 108 serves a dual purpose. One purpose is to determine an overflow level such that if this sensor 108 senses that the tailings level have reached it, then too much tailings are present in the system 10, and the process is stopped by closing the ore flow control valve 94 in order to allow the level of the tailings to fall to below the second lowest sensor 112 level. This sensor 108 also serves to monitor the level of dirt or silt that is suspended in the water. If an unacceptable level is reached, then the ore flow control valve 94 is closed in order to allow a constant flow of clean water W from the water feed system 120 to flow through the system 10 to rectify the condition. The use of the sensors 106, 108, 110, 112, and 114 monitor the overall system and control ore O flow and water W flow through the system 10 thereby allowing a precise ore O processing rate as well as a constant water W level to be maintained.

Alternately, as seen in FIG. 2, a simplified two sensor 116 and 118 configuration can be employed. In such a configuration, the upper sensor 116 is again the reference voltage sensor while the lower sensor 118 monitors the tailings at its level. If the tailings reach the level of this sensor 118, the tailings discharge valve is opened for a preprogrammed amount of time, which time is controlled by the timer 136.

While the invention has been particularly shown and described with reference to an embodiment thereof, it will be appreciated by those skilled in the art that various changes in form and detail may be made without departing from the spirit and scope of the invention.

I claim:

1. An apparatus for the beneficiation of the particulates of ore, the apparatus comprising:
a housing having a first interior space with a first upper chamber, a first lower chamber, and a discharge opening located at a first bottom of the first lower chamber;
a first valve located at the discharge opening;
a process chamber having a second interior space with a second upper chamber and a second lower chamber, the process chamber disposed within the interior space of the housing and capable of oscillating within the housing;
a frustoconical deflector disposed within the second interior chamber of the process chamber and creating an annular passageway between the second upper chamber and the second lower chamber;
a discharge chute centrally located within a second bottom of the second lower chamber;
a stratification hopper circumferentially located at the second bottom of the second lower chamber, the stratification hopper having a concentrates opening;
a second valve located at the concentrates opening;
a hopper adapted to gravitationally feed ore into the second upper chamber;
a fluid opening located on the housing below a top of the process chamber adapted to input a fluid into the housing; and
wherein the ore is adapted to be fed into the hopper and gravitationally fall into the oscillating process chamber wherein the particulates of the ore are stratified and wherein some of the particulates accumulate within the stratification hopper and others of the particulates are pushed out of the process chamber through the discharge chute and gravitationally fall into the first lower chamber with the water filling the housing.

2. The apparatus as in claim 1 further comprising a sensor disposed within the stratification hopper and capable of producing a reading of the concentration of a specific particulate within the stratification hopper such that the second valve is opened and closed based on the concentration reading of the sensor.

3. The apparatus as in claim 1 further comprising a third valve for controlling the flow of ore into the ore hopper.

4. The apparatus as in claim 1 wherein the stratification hopper has compound sloped walls.

5. The apparatus as in claim 1 wherein the first lower chamber of the housing is inwardly tapered toward the discharge opening.

6. The apparatus as in claim 5 further comprising a plurality of vertically spaced apart sensors disposed within the first lower chamber, the plurality of sensors capable of providing a reading of the particulate levels within the first lower chamber and controlling first valve based on the particulate level reading.

7. The apparatus as in claim 6 further comprising a timer for further controlling the first valve after the first valve has been opened based on the particulate level reading.

8. The apparatus as in claim 6 further comprising a third valve for controlling the flow of ore into the ore hopper such that the third valve is also controlled based on the particulate level reading.

9. The apparatus as in claim 1 further comprising at least one agitator disposed within the stratification hopper.

10. The apparatus as in claim 1 further comprising a third valve for controlling the flow of water into the housing through the fluid opening.

11. The apparatus as in claim 1 wherein the height of the deflector within the process chamber is adjustable.

12. The apparatus as in claim 1 wherein the process chamber is comprised of an upper compartment and a lower compartment such that the upper compartment is capable of being raised and lowered with respect to the lower compartment in order to adjust the height of the deflector.

13. An apparatus for the beneficiation of the particulates of ore, the apparatus comprising:
a housing having a first interior space with a first upper chamber, a first lower chamber, and a discharge opening located at a first bottom of the first lower chamber;
a first valve located at the discharge opening;
a process chamber having a second interior space with a second upper chamber and a second lower chamber, the process chamber disposed within the interior space of the housing and capable of oscillating within the housing;
a frustoconical deflector disposed within the second interior chamber of the process chamber and creating an annular passageway between the second upper chamber and the second lower chamber;
a discharge chute centrally located within a second bottom of the second lower chamber;
a stratification hopper circumferentially located at the second bottom of the second lower chamber, the stratification hopper having a concentrates opening;
a second valve located at the concentrates valve;
a hopper adapted to feed the ore into the second upper chamber;
a third valve for controlling the flow through the hopper;
a fluid opening located on the housing below a top of the process chamber adapted to input a fluid into the housing;
a plurality of vertically spaced apart first sensors disposed within the first lower chamber, the plurality of first sensors capable of providing a first reading that measures the particulate levels within the first lower chamber and controlling first valve and the third valve based on the first reading.
and
wherein the ore is adapted to be fed into the hopper and gravitationally fall into the oscillating process chamber wherein the particulates of the ore are stratified and wherein some of the particulates accumulate within the stratification hopper and some of the particulates are pushed out of the process chamber through the discharge chute and gravitationally fall into the first lower chamber with the water filling the housing.

14. The apparatus as in claim 13 further comprising a second sensor disposed within the stratification hopper and capable of providing a second reading determining the concentration of a specific particulate within the stratification hopper such that the second valve is opened and closed based on the second reading of the second sensor.

15. The apparatus as in claim 13 wherein the stratification hopper has compound sloped walls.

16. The apparatus as in claim 13 wherein the first lower chamber of the housing is inwardly tapered toward the discharge opening.

17. The apparatus as in claim 13 further comprising a timer for further controlling the first valve after the first valve has been opened based on the first reading.

18. The apparatus as in claim 13 further comprising at least one agitator disposed within the stratification hopper.

19. The apparatus as in claim 13 further comprising a fourth valve for controlling the flow of water into the housing through the fluid opening.

20. The apparatus as in claim 13 wherein the plurality of first sensors also provide a second reading determining the cleanliness of the water and control the third valve based on the second reading.

21. The apparatus as in claim 13 wherein the height of the deflector within the process chamber is adjustable.

22. The apparatus as in claim 13 wherein the process chamber is comprised of an upper compartment and a lower compartment such that the upper compartment is capable of being raised and lowered with respect to the lower compartment in order to adjust the height of the deflector.
